(19) United States
(12) Patent Application Publication
(10) Pub. No.: US 2007/0137925 A1
(43) Pub. Date: Jun. 21, 2007

(54) WALL ELEMENT WITH LATERAL CONNECTION MEANS

(75) Inventor: Thomas LORENZ, Wallenhorst (DE)

Correspondence Address: GREENBLUM & BERNSTEIN, P.L.C., 1950 ROLAND CLARKE PLACE, RESTON, VA, 20191, US

(73) Assignee: THOMAS LORENZ INDUSTRIETECHNIK GMBH & CO. KG, Wallenhorst (DE)

(21) Appl. No.: 11/561,703

(22) Filed: Nov. 20, 2006

(30) Foreign Application Priority Data
Dec. 9, 2005 (DE) 10 2005 058 770.4

(51) Int. Cl. B64F 1/26

(52) U.S. Cl. 181/210

(57) ABSTRACT

With a wall element with lateral connection means to form an interconnection with an adjacent identical wall element, the invention proposes that the connection means are embodied as a row of tabs arranged one above the other, whereby the tabs are arranged at an angle with respect to the surface plane of the wall element at least in the area of their free lateral ends, and whereby the wall element has at both sides tabs embodied to correspond with one another such that the tabs of two adjacent identical wall elements can be inserted into one another in a zipper-like manner due to their oblique position and form an interconnection to absorb forces that are directed crosswise to the surface plane of the wall element.

The invention relates to a wall element.

It is known from practice to also use wall elements outside, e.g., to erect noise barriers. The connection of the individual wall elements to one another is thereby comparatively complex, since they are either permanently connected to one another, e.g., connected to one another in a mineral manner or adhered to one another, or since the connection is made mechanically via a plurality of screws so that although a detachable connection is created, it can be created and later detached again only with a considerable expenditure in terms of time.

In particular if individual wall elements are to be removed from the noise barrier as a whole, these known wall elements make such projects either unfeasible or feasible only with a considerable amount of work.

Wall elements to be lined up next to one another are known from FR 2 458 639 A1. They are used to erect a partition wall inside a building, namely inside a room as a room divider that can be set up quickly in order to divide a large room or hall into two or more smaller rooms. Projections running in an angular manner on the two upright lateral edges of the wall elements serve as connection means to connect two identical wall elements to one another without tools. The wall elements including the connection means represent a flat component that extends in a single plane. Adjacent wall elements must therefore be aligned in an angular manner to one another so that the connection means of two wall elements can interact by the planes of these two wall elements intersecting. The embodiment of a continuously rectilinear wall is not possible.

A boltless edge connection of planar elements is known from DE 1 609 645 A. The connection means of two adjacent flat elements form a hinge and to this end project out of the plane of the rest of the flat element. From an angular position to one another in which two flat elements are first located, they can be pivoted into an extended position such that the corresponding connection means slide past one another on a curved path and mutually engage behind one another.

The ability to pivot the two adjacent flat elements with respect to one another makes it possible to arrange them in different angular positions to one another, also including the continuously rectilinear alignment of two adjacent flat elements. However, a pivoting is unavoidable in order to be able to connect the two adjacent flat elements to one another.

This is disadvantageous for two reasons:

Firstly, it is disadvantageous with large-scale or heavy flat elements, since handling them is very difficult due to the pivoting requirement.

Secondly, a use of the flat elements as wall elements that overall form a longer wall when several are lined up next to one another is disadvantageous in that one flat element cannot be detached individually from the wall as a whole, since the pivot at one of its sides is impeded by its connection to the rest of the wall on the other side. Therefore, all the flat elements would have to be gradually removed starting from one end of the wall in order to be able to remove one specific element, e.g., to be able to replace a damaged element, and subsequently the previously removed intact flat elements would have to be gradually reinstalled. This is uneconomical in practice and in fact the subject matter of DE 1 609 645 A is provided to form a hinge, e.g., of link belts, snap-on caps and the like, thus to connect only two adjacent flat elements to one another and not to create a larger lining-up of several flat elements.

The object of the invention is to create a wall element which can be connected to identical wall elements with the lowest possible effort and can be removed again from an existing wall with the lowest possible effort.

This object is attained with a wall element with the features of claim 1.

In other words, the invention proposes to effect a purely mechanical connection, namely through the embodiment of the lateral edges of the wall element itself, without additional connection means such as screws, glue or the like being necessary. Thus not only is a releasable connection created, but also a connection that is particularly easy to release, since the actuation of a plurality of connection elements is not necessary for the removal of an individual wall element from an entire wall.

A fastening system that is virtually zipper-like is created between two adjacent wall elements by the arrangement of lateral tabs set at an angle. If a wall element is lifted until the tabs mutually engaging behind are disengaged from one another, the wall element can be pivoted about its vertical axis in this lifted position so that it is disconnected from the respectively adjacent wall elements and subsequently can be removed easily. The corresponding lifting height that is necessary for this is determined by the height of the individual tabs and is drastically lower than the overall height of the wall element so that in comparison to wall elements that are guided in U profiles over their entire height and can be removed from the wall system only after being lifted out of the entire U profile, the lifting height for handling the wall element as proposed is substantially lower, which likewise reduces the labor expenditure in the assembly and disassembly of a wall element and as a result of this substantially reduced lifting height also makes considerably reduced demands on the tool required or the machines required.

A height offset of the tabs on the two sides of the wall element can advantageously be provided. In this manner, and in particular if the height offset is approximately half of the height of a tab, on the one hand a reliable mechanical locking is rendered possible between adjacent wall elements, in addition, the necessary lifting height for lifting a wall element out of the interconnection of an entire wall system is further reduced and the assembly of the wall element is simplified.

The tabs are advantageously bent in themselves so that where they connect to the wall element they connect to the wall element in a row or a line aligned with one another, but are tilted with respect to this line on their free end and thus facilitate the rear engagement of the adjacent tabs of an adjacent wall element.

Advantageously the wall element can have a plurality of openings. It thus provides a good hold for plants so that through their irregular wall surface that they form the plants on the one hand render possible a good sound insulation and on the other hand through the vegetation render possible an optimal integration of the wall into a natural environment so that the wall can be used not only as sound insulation but, e.g., also as a screening wall.

An excellent stability of the wall element with the lowest possible use of materials can also be rendered possible by bracing ribs running upright. In particular if the wall element is made of plastic, a lightweight wall element can thus be created which can easily be handled without major expenditure in terms of mechanical equipment and, e.g., can be handled by hand or at most with comparatively light equipment during assembly or disassembly.

An exemplary embodiment of the invention is explained in more detail below based on the purely diagrammatic drawings. They show:

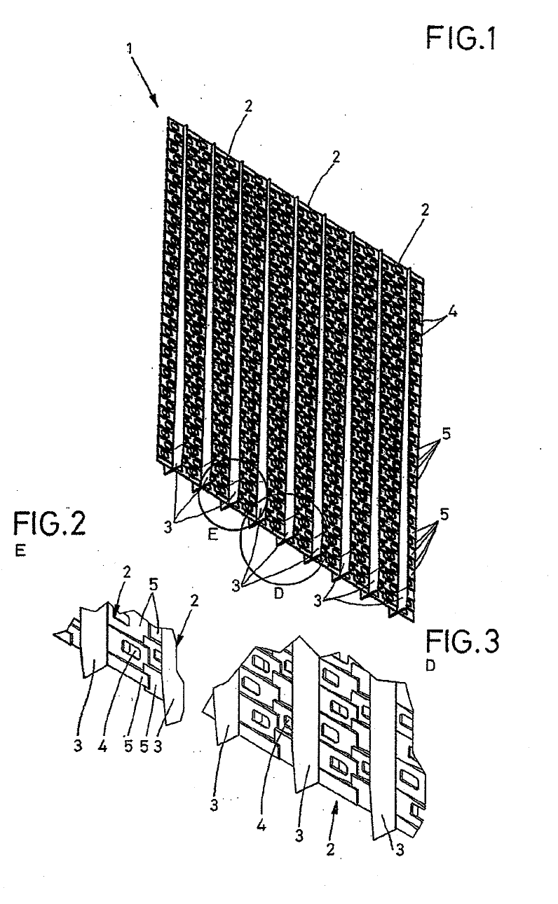

FIG. 1 A perspective view of a wall system comprising several wall elements,

FIGS. 2 & 3 Detailed views of the wall system from FIG. 1 on an enlarged scale compared to FIG. 1,

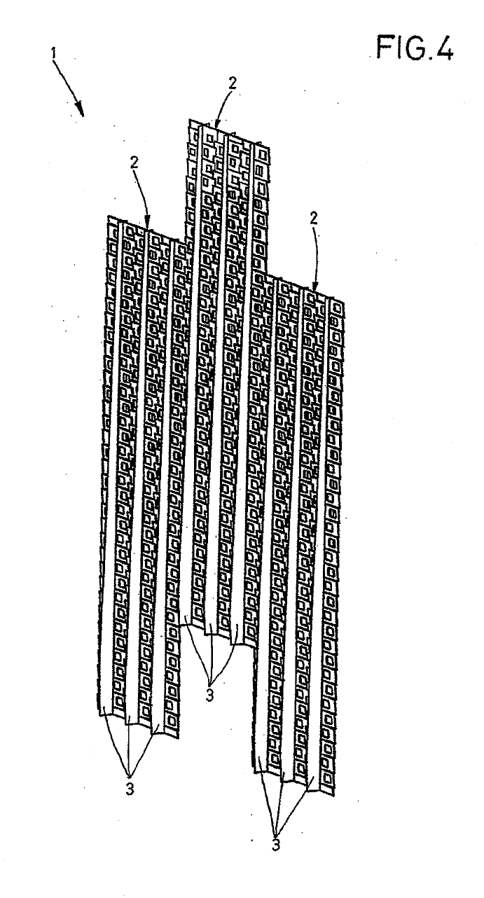

FIG. 4 A section of a wall system similar to that from FIG. 1 during the assembly or disassembly of a wall element.

In the drawings 1 is used to designate a wall system as a whole comprising several wall elements 2. Each wall element 2 has three bracing ribs 3 running upright and a plurality of openings 4.

A plurality of tabs 5 is respectively provided on both of the upright lateral edges of each wall element 2, which tabs connect to a bracing rib 3 in a continuous straight line. Starting from this straight-line alignment the individual tabs 5 are twisted in themselves so that their free end stands at an angle to the line with which they connect to the bracing rib 3. Through this, as becomes clear in particular from FIG. 2, an oblique, wedge-shaped space is formed between two tabs 5 of the same wall element 2 arranged one above the other. The tabs 5 of a respectively adjacent wall element 2 can be inserted through this wedge-shaped space so that overall an approximately zipper-like connection between the tabs 5 of two adjacent wall elements 2 is produced, as likewise can be seen clearly from FIG. 2

Whereas FIG. 2 represents a detail of the wall system 1, namely at the lower end of the wall elements 2, where two adjacent wall elements 2 are connected to one another, FIG. 3 represents an element in the view of a single wall element 2. As can be seen thereby, the entire area of the wall element 2 is embodied visually in the same or at least a very similar manner to the connection zone of two adjacent wall elements 2 so that overall the division of the wall system 1 into several individual wall elements is visually hardly noticeable with a larger wall system comprising several wall elements 2.

As is clear from FIG. 2, it is sufficient to lift one of the two wall elements 2 approximately by half of the height of a tab height in order to disengage all the tabs 5 of the adjacent wall elements 2, so that it is possible with this very small lifting height to subsequently pivot the lifted wall element 2 about its vertical axis and to thus completely release it from the adjacent wall elements 2.

In comparison, FIG. 4 shows a much higher lifting height such as is unnecessary for the disassembly or assembly of the central wall element 2. FIG. 4 serves only to illustrate that the wall system 1 shown there is composed of three individual wall elements 2.

The present application claims priority under 35 U.S.C. § 119 of German Patent Application No. 10 2005 058 770.4 filed Dec. 9, 2005, the disclosure of which is expressly incorporated by reference herein in its entirety.

1. Wall element (2), with lateral connection means to form an interconnection with an adjacent identical wall element (2), whereby the connection means are embodied as a row of tabs (5) arranged one above the other, the tabs (5) are arranged at an angle to the surface plane of the wall element (2) at least in the area of their free lateral ends, and the wall element (2) has tabs (5) embodied in a corresponding manner on both of its sides, such that the tabs (5) of two adjacent identical wall elements (2) can be inserted into one another in a zipper-like manner due to their oblique position and form an interconnection to absorb forces that are directed crosswise to the surface plane of the wall element (2).

2. Wall element according to claim 1, characterized in that the tabs (5) on one side of the wall element (2) are arranged offset in height with respect to the tabs (5) on the other side of the wall element (2).

3. Wall element according to claim 2, characterized in that the tabs (5) on both sides are offset in height such that with two wall elements (2) arranged at the same height directly next to one another the tabs (5) overlap only partially in height, whereby the tab (5) of one wall element (2) is arranged partially in front of and partially behind two tabs (5) arranged one above the other of the respectively other wall element (2).

4. Wall element according to claim 1, characterized in that the tabs (5) are respectively twisted in themselves such that the free ending lateral edge is set at an angle with respect to the lateral edge directed towards the wall element (2).

5. Wall element according to claim 4, characterized in that the lateral edges directed towards the wall element (2) are arranged in a continuous line.

6. Wall element according to claim 1, characterized by a plurality of openings (4).

7. Wall element according to claim 1, characterized by bracing ribs (3) running upright.
